(19) United States
(12) Patent Application Publication
(10) Pub. No.: US 2026/0039539 A1
(43) Pub. Date: Feb. 5, 2026

(54) REINFORCED CAUSAL STRUCTURE LEARNING FOR ONLINE ROOT CAUSE ANALYSIS

(71) Applicant: NEC Laboratories America, Inc., Princeton, NJ (US)

(72) Inventors: Zhengzhang Chen, Princeton Junction, NJ (US); Xujiang Zhao, Hillsborough, NJ (US); Haifeng Chen, West Windsor, NJ (US)

(21) Appl. No.: 19/279,025

(22) Filed: Jul. 24, 2025

Related U.S. Application Data
(60) Provisional application No. 63/678,020, filed on Jul. 31, 2024.
(60) Provisional application No. 63/680,180, filed on Aug. 7, 2024.

(51) Int. Cl. H04L 41/0631; H04L 41/16

(52) U.S. Cl. CPC H04L 41/065; H04L 41/16

(57) ABSTRACT

Systems and methods for root cause analysis (RCA) including embedding new batch data and a previous hidden state to form state-specific embedded data, forming a state-specific attributed graph with the state-specific embedded data and a directed acyclic graph (DAG) from a previous batch and decoding the DAG to learn a state-specific policy. The systems and method further include sampling an action from the state-specific policy to form a state-specific DAG and combining the state-specific DAG with an action from a state-invariant action to form a complete DAG. Some embodiments of the present invention further include evaluating the complete DAG to identify irregularities in Key Performance Indicators (KPIs) and responding, using RCA response techniques to irregularities in KPIs.

### RELATED APPLICATION INFORMATION

This application claims priority to U.S. Provisional Patent Application No. 63/678,020, filed on Jul. 31, 2024, and U.S. Provisional Patent Application No. 63/680,180, filed on Aug. 7, 2024, both incorporated herein by reference in their entirety.

### BACKGROUND

### Technical Field

The present invention relates to root cause analysis and more particularly applying reinforcement learning to directed acyclic graphs (DAGs) to discover causal relationships to improve computer systems.

### Description of the Related Art

Directed acyclic graph (DAG) methods can be categorized into four types; (1) constraint based methods, (2) score based methods, (3) continuous optimization methods, and (4) sampling based methods. Constraint based methods use conditional independence (CI) tests to recover the skeleton of the DAG and then orient the edges to determine the Markov equivalence class of the DAGs. These methods depend on the accuracy of CI tests and conflicts in CI tests can undermine their robustness. Score-based methods utilize score functions (e.g., Bayesian Information Criterion (BIC)) to evaluate the fit of DAGs to the data but are difficult to implement in large DAGs.

Continuous optimization methods solve combinatorial optimization with a smooth characterization of acyclicity. This aims to obtain global approximate solutions for causal graphs but often struggle due to the locality of heuristic strategies. Sampling-based methods estimate the posterior distribution over DAGs using Markov Chain Monte Carlo (MCMC) techniques to sample DAGs but are computationally intensive.

Ordering-based methods consider DAGs as variable ordering problems that use a Markov Decision Process (MDP), which can reduce the search space to ordering. Ordering-based methods map the ordering to a fully connected (FC) DAG and then perform variable selection to estimate the DAG. These methods avoid dealing with acyclicity directly but are sequential, making them unsuitable for parallelization. Also, they are inefficient in online settings, and their performance depends on the chosen variable selection technique.

### SUMMARY

According to an aspect of the present invention, a method is provided for root cause analysis (RCA). The method includes embedding new batch data and a previous hidden state to form state-specific embedded data, forming a state-specific attributed graph with the state-specific embedded data and directed acyclic graph (DAG) from a previous batch, and decoding the DAG to learn a state-specific policy. The method further includes sampling an action from the state-specific policy to form a state-specific DAG and combining the state-specific DAG with an action from a state-invariant action to form a complete DAG. The method can also include evaluating the complete DAG to identify irregularities in Key Performance Indicators (KPIs) and responding, using RCA response techniques, to irregularities in KPIs.

According to another aspect of the present invention, a system is provided for a memory device for storing program code, and a processor device, operatively coupled to the memory device. The memory causes the system to embed new batch data and a previous hidden state to form state-specific embedded data, form a state-specific attributed graph with the state-specific embedded data and a DAG from a previous batch, and decode the DAG to learn a state-specific policy. The memory further causes the system to sample an action from the state-specific policy to form a state-specific DAG and combine the state-specific DAG with an action from a state-invariant action to form a complete DAG. The memory can also cause the system to evaluate the complete DAG to identify irregularities in KPIs and respond, using RCA response techniques, to irregularities in KPIs.

According to yet another aspect of the present invention, a computer program product for RCA is discussed herein. The computer program product includes a non-transitory computer readable storage medium having program instructions embodied therewith. The program instructions executable by a computer to cause the computer to perform a method include embedding new batch data and a previous hidden state to form state-specific embedded data, forming a state-specific attributed graph with the state-specific embedded data and a DAG from a previous batch, and decoding the DAG to learn a state-specific policy. The program instructions further includes sampling an action from the state-specific policy to form a state-specific DAG and combining the state-specific DAG with an action from a state-invariant action to form a complete DAG. The program instructions can also cause the computer to include evaluating the complete DAG to identify irregularities in KPIs and responding, using RCA response techniques, to irregularities in KPIs.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system applying the DAG RL framework for RCA, in accordance with an embodiment of the present invention;

FIG. 2 is a diagram illustrating the formation of the DAG RL framework, in accordance with an embodiment of the present invention;

FIG. 3 is a block diagram illustrating the iterations of the batches of data forming the DAG RL, in accordance with an embodiment of the present invention;

FIG. 4 is a block diagram illustrating the formation of a DAG based on state-specific and state-invariant information, in accordance with an embodiment of the present invention;

FIG. 5 is a block diagram illustrating an application of the DAG RL into a computer environment, in accordance with an embodiment of the present invention;

FIGS. 6-7 are a flow diagram illustrating a method for performing and applying the DAG RL, in accordance with an embodiment of the present invention;

FIG. 8 is a block diagram illustrating a computer architecture where the DAG RL can be performed, in accordance with an embodiment of the present invention; and

FIG. 9 is a block diagram illustrating an artificial neural network integrated into embodiments of the present invention.

### DETAILED DESCRIPTION OF PREFERRED EMBODIMENTS

Identifying root causes in root cause analysis (RCA) is helpful in a variety of disciplines, including economics, healthcare, information technology (IT) services, etc., where there may be many entangled variables. In these environments, each variable may causally affect a result but the numerosity of entangled variables makes determining causal relationships difficult, impractical, or impossible to test without disentangling the variables.

Currently, troubleshooting many problems is performed manually. This can be time-consuming, labor-intensive, and error prone due to the large number and complex dependency relationships. Additionally, failing to solve problems, or solving them in an untimely manner can cause significant monetary or other losses. Therefore, learning how to efficiently and promptly detect root causes is becoming increasingly beneficial.

For example, in healthcare, combining medications can make tracking biological changes to the independent variable(s) difficult due to the complex nature of biological organisms. A directed acyclic graph (DAG) can identify the cause(s) of an effect by determining the causal relationships between variables (e.g., treatments, symptoms, conditions, genetics, etc.). The DAG can map a causal chain from root cause to a symptom to facilitate better and faster treatment.

In IT, DAGs can be applied to RCA to identify network or system issues. Businesses are integrating an increasing number of internet applications. With this ever-increasing integration, when an application fails, there may be an outage which causes a cascade of other application failures. In complex systems that use microservices, these failures are all but inevitable due to unforeseen circumstances, edge cases, problems with newly implemented code, etc. These failures make identifying the cause (e.g., RCA) useful to preserve user experience, among other benefits.

A solution that can perform RCA online is also advantageous because the solution can receive data in several batches. Having several batches instead of a single batch once a state is completed can be advantageous because the system can update more frequently, adapt faster, and make real-time or near real-time decisions, unlike offline solutions. Embodiments of the present invention use online DAGs for RCA. Embodiments of the present invention also use reinforcement learning (RL) to search for root causes effectively and supply explainable rewards.

DAGs function by minimizing a score function ( [symbol] ) with respect to observed data, which can be represented by:

$${min}_{\hat{𝒢}} 𝒮 ( \hat{𝒢} , X ) , such that \hat{𝒢} ∈ DAGs$$

where [symbol] is a DAG and X is observed data. There are flaws with traditional DAGs however. Traditional DAGs are NP-hard due to the super-exponential growth of the DAG space with the number of nodes (e.g., variables) they include, and DAGs may be cyclic.

RL can address these problems. DAG RLs can address the drawbacks of continuous optimization methods by offering interpretable reward mechanisms that address the limitations of local heuristic methods. RL maps a continuous real valued space to the DAG space.

Current implementations of DAG RLs train an RL agent to search for high-reward DAGs which incorporate implicit penalty terms in the reward function to enforce acyclicity and search across the entire directed graph space. This is computationally inefficient and is difficult to scale. Additionally, these solutions do not actually guarantee acyclicity.

Embodiments of the present invention are more computationally efficient, can guarantee acyclicity, and can facilitate efficient and scalable incremental intra-batch learning by using a multi-agent search. Intra-batch learning can be performed online and is advantageous because the system processes model updates faster and the batches allow the DAG to converge to a stable graph faster for a given state.

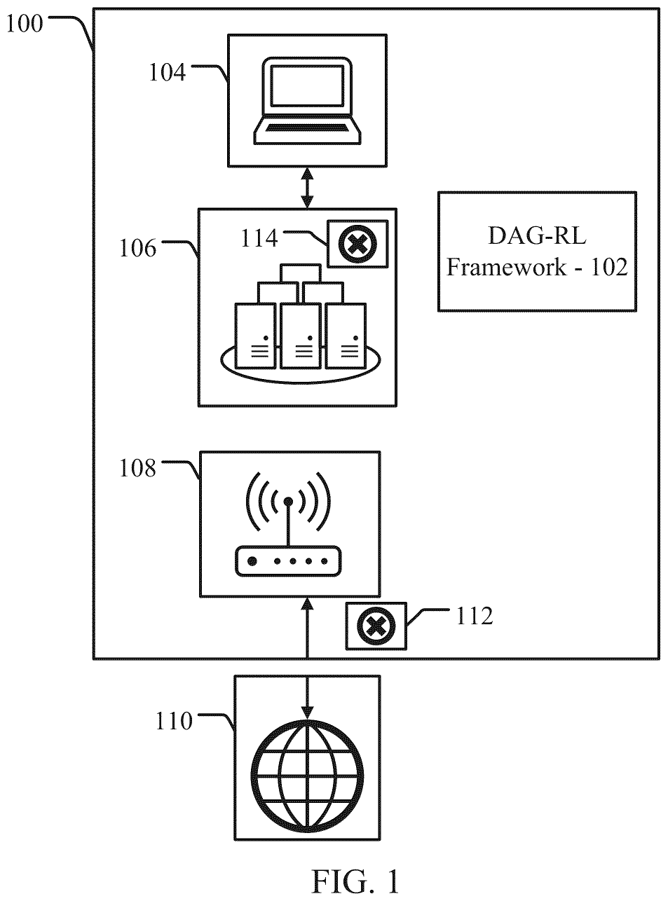

Referring now in detail to the figures in which like numerals represent the same or similar elements and initially to FIG. 1, a high-level block diagram for the DAG RL framework for RCA is illustratively depicted in accordance with an embodiment of the present invention. A network 100 can include a DAG RL framework 102, an end user 104, a local server 106, and an external network connection device 108. DAG RL framework 102 can identify errors and faults in network 100. These faults and errors can reduce network 100 efficiency, capability, or access to information, among other problems.

In alternative embodiments of the present invention the DAG RL framework can uncover root causes and causal patterns in other situations. In IT, DAG RL can prevent cascading failures such as dependencies between microservices where one microservice that enables other microservices (even when they are seemingly unrelated, e.g., an authentication microservice fails leading to a failure in completing a purchase). DAG RL can also prevent performance bottlenecks under load by learning how key performance indicators (KPIs) like latency and throughput are influenced by metrics like controller processing unit (CPU) usage, memory, and input/output (I/O) usage. This can identify which subsystem or component is causally responsible for degraded performance under specific usage patterns.

In healthcare, DAG RL can assist in disease progression modeling and misdiagnosis or diagnostic delay. Disease progression modeling often can involve a variety of factors that are not initially apparent. The DAG RL can get closer to discovering the causal chain with each batch/state of additional information. This can assist in identifying early predictors of disease progress or relapse. Misdiagnosis or diagnostic delay can occur due to overlapping symptoms, especially for uncommon conditions that have symptoms in common with more common conditions. The DAG RL can learn which symptom causally relate to true condition across large patient datasets.

In manufacturing, equipment failure RCA and process drift/quality degradation can employ a DAG RL framework. Equipment failure RCA can use DAG RL to compare sensor readings with failure events. In process drift and quality degradation situations, DAG RL can track changes in final products from the components that are built from. For example, material source/quality can affect output quality. In these situations, DAG RL can learn and update causal models over time; disentangle invariant and transient causes; operate in real time or near-real time; and trigger alerts, explain failures, and guide automated or human remediation. DAG RL can also identify beneficial attributes, such as profit centers of a business as opposed to cost centers.

DAG RL framework 102 can identify errors by reviewing the information collected in the system from metrics, KPIs, and other sources to review to network 100 health and performance at different locations and points in time. With each batch of data, a DAG is formed and refined until the DAG converges and RCA methods can apply diagnostic solutions.

With each new batch the DAG is modified with the goal of converging (becoming stable, e.g., the DAG does not change between batches, or changes less than a given threshold). The DAG is continuously being reviewed to identify causal relationships and determine the root cause. DAG RL framework 102 can run continuously to monitor network 100 or once a problem is detected.

End user 104 can use a computer, a laptop, a phone, an internet of things (IoT) device, or other edge devices that can be connected to local server 106 and/or external network connection device 108. Local server 106 can provide local memory storage between end users 104 within network 100. External network connection device 108 can connect end users 104 and local server 106 to internet 110. DAG RL framework 102 can identify a connectivity issue 112 between external network connection device 108 and internet 110. Additionally, or alternatively, DAG RL framework 102 can identify a misconfiguration issue 114 in local server 106 which causes end user 104 to have limited access to the information stored on local server 106.

In some embodiments of the present invention, DAG RL framework 102 can apply identified problems and diagnoses to understand patterns and predict outages or other issues in the network before they occur. DAG RL framework 102 can apply machine learning techniques, other forms of artificial intelligence, and/or other forms of processing and pattern recognition to analyze the data. For example, if network 100 uses a third-party service that regularly reports outages after “pushing” an update, DAG RL framework 102 can learn to warn end user 104 and/or develop work around solutions prior to the outage actually occurring. DAG RL framework 102 can also initiate measures for automatic remediation for outages; improve network performance; identify, notify and/or patch network security concerns; create benchmarks; augment intrusion detection systems; support self-healing systems; recommend preventative actions; serve as a diagnostic layer, etc.

Additionally, DAG RL framework 102 can act as a causal decision engine that feeds interpretable diagnostics to monitoring dashboards or AIOps (artificial intelligence for IT operations) tools. In other embodiments of the present invention DAG RL framework 102 can integrate with continuous integration and continuous delivery/deployment (CI/CD) systems to evaluate the causal impact of deployments. In other words, DAG RL can be a tool regularly used by IT for system monitoring (proactively) as well as troubleshooting (reactively) and can aid in improving software development and integration.

While DAG RL framework 102 is depicted outside local server 106, DAG RL framework 102 can be partially or completely within local server 106.

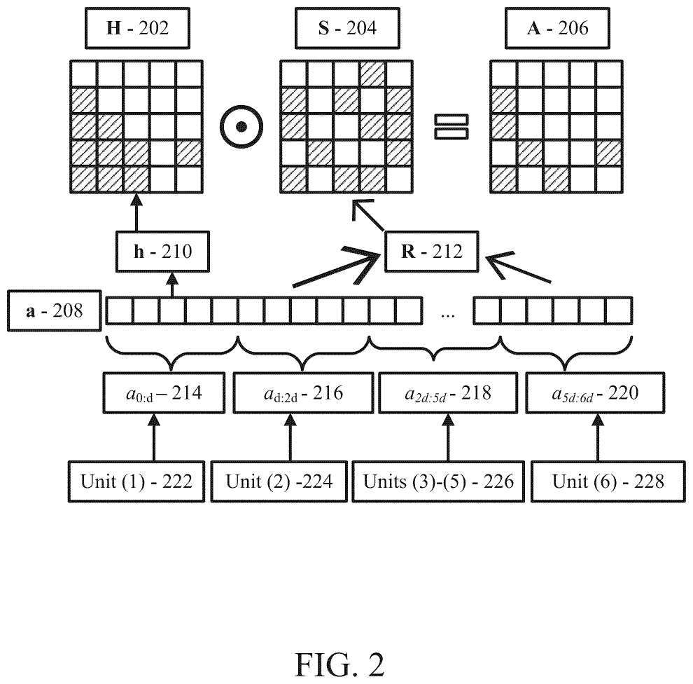

Referring to FIG. 2, a system diagram of DAG RL framework 102 is illustrated in greater detail. A structural equation model (SEM) which relates to DAG will be described. DAG [symbol] is defined as [symbol] ={ [symbol] , ε}, where each node vᵢ∈ [symbol] ={v₁, . . . , v_{d}} is associated with a random variable Xᵢ∈ [symbol] ={X₁, . . . , X_{d}}, each directed edge (vᵢ, vⱼ)∈ε={{(vᵢ, vⱼ)|i,j=1, . . . , d and i≠j} indicates that Xᵢ is a direct cause of Xⱼ. The DAG can be represented by a binary adjacency matrix A∈{0, 1}^{d×d} where the (i,j)-th entry is 1 if (vᵢ, vⱼ)∈ε, and otherwise is 0. The joint distribution associated with the DAG can be decomposed into

$$P ( {X}_{1} , … , {X}_{d} ) = {\prod }_{i = 1}^{d} P ( {X}_{i} \vert Pa ( {X}_{i} ) ) ,$$

where Pa(Xᵢ)={Xₖ|(vₖ, vᵢ)∈ε} is the set of parents of Xᵢ. There is an assumption that the data generation process conforms to a SEM with additive noise according to Xᵢ=fᵢ(Pa(Xᵢ))+ηᵢ, i=1, . . . , d where fᵢ(⋅) represents the causal relationship between Xᵢ and the parents Pa(Xᵢ), and the additive noise terms ηᵢ are assumed to be jointly independent. There is also an assumption of causal minimality, meaning that each fᵢ(⋅) is not constant with respect to any argument.

Causal minimality is an application of Occam's Razor in which there is an understanding that there are no redundant causes, and the minimal graph structure is preferred. No redundant causes is defined as not including any cause that is not necessary (e.g., if A and B cause C, but A alone also causes C, then A and B are not the minimum cause of C, A alone is). This prevents irrelevant factors from being included in a description of a cause and seeks the smallest set of conditions necessary and sufficient for the effect. Minimal graph structure prefers graphs with the fewest number of causal arrows (edges). In other words, the DAG only includes the minimum number of relationships between variables, and the system avoids adding superfluous connections.

Causal minimality helps the system avoid becoming too complex. By keeping the minimum number of connections, the resulting graph is simpler, easier to understand, and less likely to be influenced by random patterns in the data. Additionally employing causal minimality improves the system's ability to work with new or changing data and provides a clearer explanation that can be used to make decisions or take action. In short, causal minimality helps the system focus on the important factors, leading to more accurate and useful results.

RL employs a policy π to learn an action a to search the DAG space. The policy π selects a continuous action a from the real valued space, which in turn determines the DAG of d nodes. A reward [symbol] is calculated using a score function [symbol] : [symbol] (a, X)=− [symbol] ( [symbol] (a), X) where a is a real valued vector, X are observations, and [symbol] is a function that takes a real-valued action vector a and maps the vector to a corresponding DAG. The function splits the real-valued vector a into two parts, one part forms a fully connected (FC) graph structure that ensures the graph is acyclic, and the other part forms a binary mask that filters which edges remain. The output of [symbol] (a) is a DAG ( [symbol] ), represented by an adjacency matrix A, where A=H⊙S, with H derived from one part of a (the FC graph) and S derived from the other (the binary mask). Thus, [symbol] is the transformation that converts a numeric vector (output of the RL policy) into a structured, acyclic graph that represents causal relationships between variables. The operator ⊙ is a Hadamard product which derives matrices from a real valued vector to establish a mapping from a continuous real space to the DAG space and can implicitly ensure acyclicity.

A Bayesian Information Criterion (BIC) score is used when forming the graph. The DAG RL seeks to perform the average best score of the function described across all system states as:

$${min}_{{\hat{𝒢}}_{1} , … , {\hat{𝒢}}_{m}} \frac{1}{m} {{\sum }_{t = 1}}^{m} 𝒮 ( {\hat{𝒢}}_{t} , {X}_{t} ) , such that {\hat{𝒢}}_{t} ∈ DAGs , and$$

$${\hat{𝒢}}_{t} \neq {\hat{𝒢}}_{t + 1} , {∀}_{t}$$

where m is sequentially continuous sets of observations Xₜ∈ [symbol] for the given dataset

$$𝒟 = {\{ {X}_{t} \}}_{t = 1}^{m} .$$

Each Xₜ corresponds to a system state pₜ, with nₜ observations, and is associated with a DAG [symbol] . In an online setting, data for each system state pₜ arrives in batches of size b, denoted by

$${X}_{t} = {[ {( {X}_{t}^{1} )}^{T} , … , {( {X}_{t}^{L} )}^{T} ]}^{T} ,$$

where Xₜ^{l}∈ [symbol] , l=1, . . . , L, represents the l-th batch of Xₜ and is associated with the DAG [symbol] , which captures the causal mechanisms of the current batch data. Alternative embodiments can employ Akaike Information Criterion (AIC), Minimum Description Length (MDL), Structural Intervention Distance (SID), log-likelihood, and mean squared error (MSE), depending on the application and data type. Embodiments of the present invention can employ a single transition RL (e.g., T=1) or multi-step RLs.

In alternative embodiments of the present invention, the Hadamard product can be replaced with attention-weighted matrices, sigmoid gating mechanisms, thresholded Rectified Linear Unit (ReLU) masks, regularization-based sparsity, etc. Attention-weighted matrices use learned edge weights instead of binary masks. This allows for soft selection of edges. Sigmoid gating mechanisms apply sigmoid activations to generate soft masks, which can be thresholded to produce binary adjacency matrices. Thresholded ReLU masks use ReLU followed by hard thresholding to select edges. Regularization-based sparsity applies mean absolute error loss (L1) penalties or entropy constraints to encourage sparse graphs.

The matrix can be A=P^{T}UP where A∈{0,1}^{d×d} is the adjacency matrix of a DAG, P∈{0,1}^{d×d} is a permutation matrix, and U∈{0,1}^{d×d} is a strictly upper-triangular matrix. The matrix U represents the adjacency matrix of a graph that ensures acyclicity with all directed edges (vᵢ, vⱼ) satisfying i<j. This captures all subsets of a FC DAG corresponding to the initial ordering of nodes where node vᵢ∈ [symbol] is in the i-th position. The permutation matrix changes the order of nodes in this initial ordering, resulting in a graph with the same topological structure.

Consequently, the permutation matrix represents all subsets of the FC DAG corresponding to the altered ordering allowing the adjacency matrix to cover the entire DAG space. Accordingly, the adjacency matrix can be obtained from a FC DAG 202 (H) and a binary mask matrix 204 (S). FC matrix 202 ensures no backward edges exist when nodes are topologically ordered. FC DAG 202 is derived from a portion of single real valued vector 210 (h).

Since binary mask matrix 204 can be obtained by filtering a real valued matrix of the same shape with a simple threshold to produce a binary matrix, for any given real valued vector 208 (a) of dimension d(d+1), FC matrix (DAG) 202 can be generated from the first d dimensions and a binary mask matrix 204 from the subsequent d² dimensions thereby obtaining an adjacency matrix 206 (A). Adjacency matrix 206 encodes the structure of a DAG. FC matrix 202 is a fully connected, acyclic graph (upper triangular) and binary mask matrix 204 is a binary mask.

In accordance with an embodiment of the present invention, nodes d can be dividing into sections of five (5) where the total vector length is thirty (30) meaning there are six (6) slices. The slicing forms slice 214, slice 216, slice 218, and slice 220 which correspond to indices in real value vector 208. Note these slices are by way of demonstration only, they be smaller or larger than five (5) indices to each slice and the vector length can be smaller or larger than thirty (30). Slice 218 demonstrates several slices for the sake of brevity.

Slice 214 corresponds to unit (1) 222 which forms FC matrix 202 from portion of single real valued vector 210. Since the first 5 indices are applied to FC matrix 202 there are 25 remaining with a square number. The 25 remaining indices can form binary mask matrix 204 as a square matrix. Slice 216 corresponds to unit (2) 224. Slice 218 corresponds to units (3)-(5) 226 for the sake of brevity. Slice 220 corresponds to unit (6) 228. Slices 216, 218, and 220 form binary mask matrix 204. Embodiments of the present invention are improved over implementations in the prior art that require an acyclicity restraint.

The formation of FC matrix 202 and binary mask matrix 204 can be performed in parallel with other processing units to expediate the process. The first processing unit learns the portion of the action space responsible for generating FC matrix 202 while the remaining units collaboratively handle the portion used to generate binary mask matrix 204. The ability to parallelize the processing of FC matrix 202 and binary mask matrix 204 allows more processing units to assist in the RCA, making the process as a whole faster. Faster processing then makes DAG generation faster, and DAG convergence faster. This can lead to expediting the RCA process altogether and identification and resolution of the problem.

DAG RL factors the action vector into subspaces (e.g., one subspace forms FC matrix 202, others form binary mask matrix 204) where each subspace can be handled by an independent RL agent or processing unit. This parallelism enables faster DAG generation across batches, reduced inference time, improving real-time applicability, better scaling to high-dimensional data, and in a computing context, this improves throughput and latency, optimizing system resources (e.g., GPU cores, threads). The processing units can be software, or hardware, or a mixture of both.

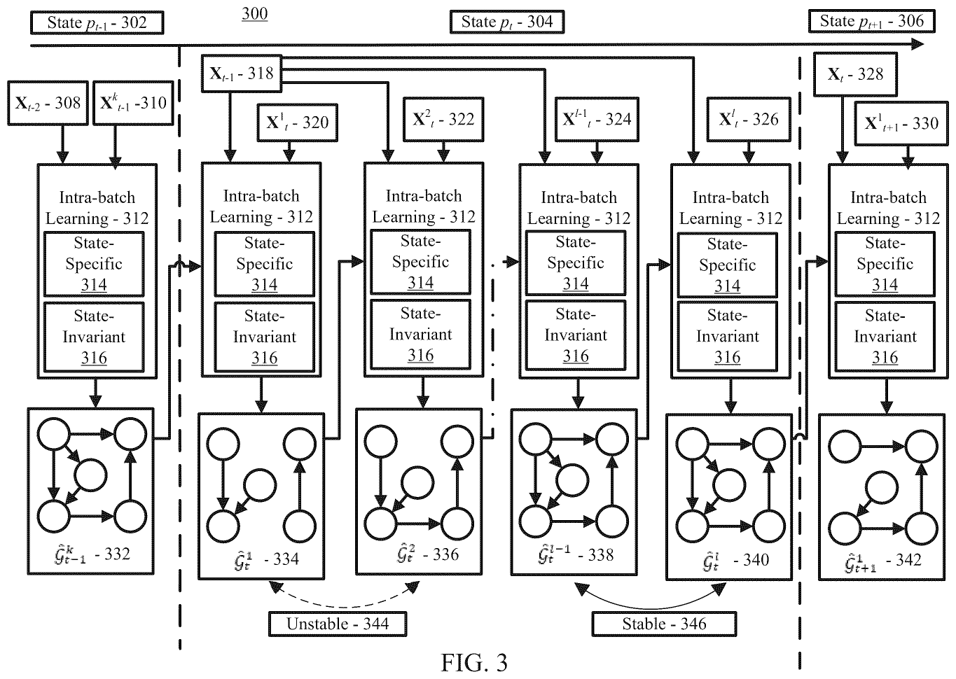

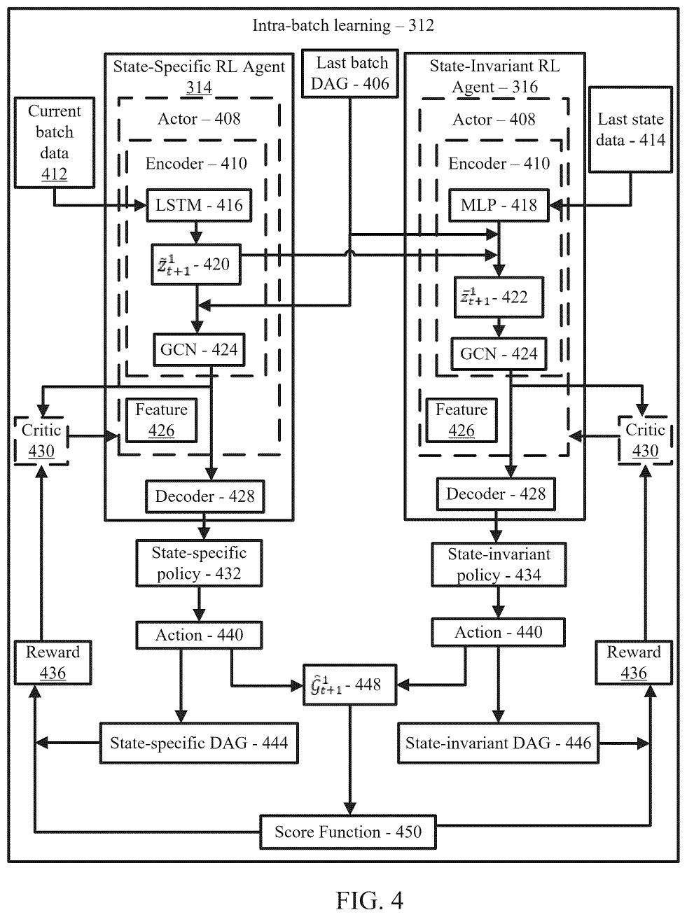

Referring to FIGS. 3-4, a block diagram of the DAG RL is illustrated. Incremental learning, which is depicted in FIG. 3, enables a model to update incrementally (iteratively) when new data arrives. This eliminates the need to retrain the model from scratch, like in offline DAG RLs. Each agent (state-specific and state-invariant) contributes to building the one-step reinforced DAG learning module. A state-invariant RL agent 316 incrementally learns causal relationships that remain consistent across different system states and the state-specific RL agent 314 identifies causal relationships unique to the current system state.

DAG RL pipeline 300 includes three exemplary states, previous state 302, current state 304, and next state 306. Within DAG RL pipeline 300 is intra-batch learning 312 which includes state-specific RL agent 314 and state-invariant RL agent 316. Further detail into intra-batch learning 312 will be described in FIG. 4. In other embodiments of the present invention, DAG RL pipeline 300 can consider more states for multi-step RLs.

Graph 332 is associated with the previous state 302. Previous state 302 includes previous state data 308 (e.g., data from two states ago from the current state) and batch data 310. Graph 332 is a valid (e.g., converged, stable) DAG.

Graph 334 and graph 336 are graphs from current state 304 and are both unstable 344. The DAGs continue to converge (e.g., change shape). This is reflected in FIG. 3 since graph 334 and graph 336 are not the same as graph 338 and graph 340 which are the same as each other. In graph 334 there are three nodes separate from another two nodes. This means the dependencies may not be known since not all the nodes are connected. A fully converged DAG is a graph that has all of the nodes connected. Additionally, the graph does not change between batches, or changes very little between batches. Note that merely not changing between two consecutive batches does not ensure a DAG is converged, in some embodiments of the present invention a DAG can change in non-consecutive batches.

Graph 334 has information from previous state data 318 and batch data 320. Previous state data 318 can be from previous state 302, like previous state data 308 is included in intra-batch learning 312 of the state before previous state 302. Batch data 320 is one sub-space that is being evaluated. The DAG RL sub-groups the space into several batches.

Batch data 322, batch data 324, and batch data 326 are different subspaces that are each combined with previous state data 318 to review the DAG for RCA in that sub-space. Graph 332 is input into intra-batch learning 312 of current state 304 with information associated with batch data 320. DAG graph 334 which results is then input into intra-batch learning 312 for batch data 322. This continues for DAG graph 336 into intra-batch learning 312 for batch data 324.

Note there may be more intra-batch learning 312 and DAG graphs generated in between batch 322 and batch 324. In other words, there can be any number of graphs and subspaces. The number and configuration of the graphs in FIG. 3 are only for illustrative purposes. To put this simply, FIG. 3 is only an exemplary embodiment of the present invention, other embodiments may have more or less batches of data and consequently a corresponding number of DAGs. Also, the number of variables (nodes) on the DAG may also but a different number than 5. Graph 338 is fed into intra-batch learning 312 with batch data 326 which produces graph 340. Graph 340 is the last DAG of current state 304 and batch data 326 is the last batch of current state 304.

After current state 304, is next state 306 which has previous state data 328 which is associated with (e.g., is the same as) current state 304 and batch data 330. Previous state data 328 and batch data 330 are input into intra-batch learning 312 and form graph 342. Technically graph 342 can be stable 346 in the initial batch, though this is unlikely. Stable 346 DAG can be used to analyze the system by identifying components that are not consistent throughout the system (state-specific) and those that are (state-invariant). In some embodiments of the present invention, Jensen-Shannon divergence can be used to compare DAGs between batches. In one embodiment of the present invention, a threshold convergence value of ξ≥0.95 can indicate a stable 346 DAG and pause further updates (preventing unnecessary computation and overfitting).

Referring to FIG. 4, the intra-batch learning 312 is demonstrated in further detail. The RL considers state-specific RL agent 314 and state-invariant RL agent 316 separately and together. In a computer environment, state-specific variables can include cache contents, load balancer routing, temporary firewall exceptions, and container memory pressure due to changes in users. State-invariant variables can include core service dependencies (e.g., authentication to billing), network topology (if static), and application DAGs in monoliths.

In healthcare a state-specific variable can include a fever in response to an infection while a state-invariant variable could be genetic predisposition to diabetes. In manufacturing a state-specific variable can include sensor faults while a state-invariant variable can include a mechanical link between machine components.

Due to the ability to handle continuous action spaces stably and efficiently, an actor-critic algorithm is used to improve the search and implement the DAG using neural networks with parameters yr. The algorithm uses an encoder-decoder architecture and takes the state as input, learns the means and variances of the policy, then selects a continuous action (real value vector 208 (FIG. 2)) and calculates reward 436. Critic 430, which can include a value network (VNet), evaluates the actions generated by an actor 408 so that the actor 408 can update the policy based on the evaluation score produced by score function 450. Further, critic 430 penalizes terms to assist in differentiating state-specific and state-invariant information.

Critic 430 evaluates the quality of the action (e.g., the DAG generated by state-specific RL agent 314 and state-invariant RL agent 316) and computes the expected return or score of the selected action and helps the actor update the policy via the policy gradient. In some embodiments of the present invention critic 430 evaluates decoupling losses which encourages the agents to specialize and balances the BIC score with the diversity or stability of the DAGs. To put this simply, critic 430 stabilizes training and helps agents specialize in disentangling causality.

State-invariant RL agent 316 is used to incrementally learn the causal relationships that are invariant across system states, and a state-specific RL agent 314 to quickly identify causal relationships specific to the current system state in multiple batches. This disentanglement mechanism allows the DAG RL to understand state-specific causal mechanisms using the incrementally updated state-invariant information as prior knowledge when facing new data distributions, enabling efficient inter-batch incremental DAG learning.

Offline DAG RL solutions can only consider a single state as a batch once the state has been completed. This means that the convergence of the DAG is the same as the end of the state, which is not necessarily true for embodiments of the present invention. Also, there can be reductions in DAG RL accuracy if there is only a single batch because the RL cannot finetune based on information received in a previous batch. Offline DAGs also cannot incorporate past knowledge and need to retrain from scratch each batch (state).

Assuming that the incoming data is the l-th batch for system state pₜ. The state-specific RL agent 314 aims to learn the new causal relationships introduced by the current data batch

$$412 ( {X}_{t}^{l} ) .$$

To track information changes between different batches, the encoding component (encoder 410) uses both current data batch 412 and the previous hidden state as inputs to a long short-term memory network 416 (LSTM) to obtain embedding

$$420 ( {\tilde{z}}_{t}^{l} )$$

for the current batch. The previous hidden state is the output of the LSTM from the previous batch

$$( {\tilde{z}}_{t}^{l - 1} )$$

and is used to maintain temporal continuity. Embedding 420 is then combined with the DAG from a previous batch DAG

$$406 ( {𝒢}_{t}^{l - 1} )$$

to form an attributed graph, which serves as prior structural knowledge. Previous batch DAG 406 and embedding 420 are encoded using a graph convolutional network 424 (GCN).

Feature 426 refers to node-level attributes in the attributed graph input to the GCN. Feature 426 can include embeddings from the LSTM and MLP as well as graph topological information. Feature 426 is useful for informing edge likelihoods in the DAG generation.

After, the graph is processed by GCN 424 and decoder 428 is used to learn a state-specific policy

$$432 ( {\tilde{π}}_{t}^{l} ) .$$

State-specific policy 432 samples an action

$$440 ( {\tilde{a}}_{t}^{l} )$$

to generate the state-specific DAG

$$444 ( {\tilde{𝒢}}_{t}^{l} ) ,$$

which is then combined with the action

$$442 ( {\overline{a}}_{t}^{l} )$$

sampled from state-invariant policy

$$DAG 448 ( {\hat{𝒢}}_{t}^{l} )$$

to produce a fusion action which is defined as

$${\hat{a}}_{t}^{l} = β {\tilde{a}}_{t}^{l} + ( 1 - β ) {\overline{a}}_{t}^{l} ,$$

where β∈[0,1] is used to balance the importance of state-specific information and state-invariant information. Complete

$$DAG 448 ( {\hat{𝒢}}_{t}^{l} )$$

is then obtained. Since the real value vector 208 (FIG. 2) maps to FC matrix 202 and binary mask matrix 204 via thresholds and comparisons which determine the structure of the DAG, using the fusion action from state-specific RL agent 314 and state-invariant RL agent 316 complete DAG 448 is formed.

To ensure accurate discovery of state-specific information, a decoupling term is introduced in the reward to encourage the estimated state-specific DAG 444 to be as distinct as possible from both the state-invariant DAG from a previous batch

$${\overline{𝒢}}_{t}^{l - 1}$$

and the graph from previous state graph 332. Critic 430 is trained to approximate the score function 450 which the decoupling term is added to. The role of critic 430 in the actor-critic 430 setup is to evaluate the expected return of an action (including contributions from both the BIC score and the decoupling loss). Therefore, while critic 430 helps state-specific RL agent 314 and state-invariant RL agent 316 learn policies that respect the decoupling constraint, critic 430 does so indirectly by learning from rewards that already include it. The decoupling term is defined as:

$${ℒ}_{{\tilde{𝒢}}_{t}^{l}} = ( {‖ {\tilde{A}}_{t}^{l} - C {\overline{A}}_{t}^{l - 1} ‖}^{2} + {‖ {\tilde{A}}_{t}^{l} - C {\overline{A}}_{t - 1} ‖}^{2} ) / d$$

where d is the number of nodes in adjacency matrix 206 and CA refers to the complement of the adjacency matrix 206, which converts “0”s in adjacency matrix 206 to “1”s and “1”s to “0”s.

The current reward 436 is defined as

$${\tilde{ℛ}}_{t}^{l} = - 𝒮 ( {A}_{t}^{l} , {X}_{t}^{l} ) + {λ}_{1} {ℒ}_{{\tilde{𝒢}}_{t}^{l}} ,$$

where λ₁ represents the weight between the decoupling term and the BIC score. Since the state-specific information depends highly on the system state, the state-specific RL agent 314 is reinitialized at the beginning of each new system state.

State-invariant RL agent 316 learns the invariant causal relationships across multiple system states and is operated with several similarities to state-specific RL agent 314. The encoding part first uses an FC layer to encode the previous state data 318 (Xₜ₋₁) into embedding

$$( {\overline{z}}_{t - 1} ) .$$

Since state-invariant causal relationships are influenced by both previous state data 318 and batch data, embeddings affiliated with both

$$( {\overline{z}}_{t - 1} and {\tilde{z}}_{t}^{l} )$$

are concatenated to obtain embedding

$$422 ( {\overline{z}}_{t}^{l} )$$

using a multi-layer perceptron (MLP).

After encoder 410 is applied to embedding 422, the attributed graph formed by previous batch DAG 406 and embedding 422 using GCN 424. State-invariant policy 434 is learned through decoder 428 to obtain the state-invariant DAG

$$446 ( {\overline{𝒢}}_{t}^{l} ) .$$

State-invariant DAG 446 is then combined with state-specific DAG 444 to produce DAG

$$448 ( {𝒢}_{t}^{l} ) .$$

Complete DAG 448 is also the input DAG for the next state and may be annotated as

$${𝒢}_{t}^{l + 1}$$

to denote that the DAG may be present in the next iteration and may not be the final batch or final state.

Another decoupling term is introduced to ensure that the estimated state-invariant DAG 446 is as dissimilar as possible to the state-specific DAG from a previous batch

$${\tilde{𝒢}}_{t}^{l - 1}$$

while remaining similar to the DAG from the previous state data 318. The decoupling term is defined as:

$${ℒ}_{{\overline{𝒢}}_{t}^{l}} = {‖ {\overline{A}}_{t}^{l} - C {\tilde{A}}_{t}^{l - 1} ‖}^{2} + {‖ {\overline{A}}_{t}^{l} - {A}_{t - 1} ‖}^{2} .$$

A different critic 430 is used with this decoupling term than the state-specific RL agent 314. Each critic 430 follows the same general architecture and learning objective, they are trained separately and apply their own reward 436 respectively, which include distinct decoupling terms tailored to their respective roles. The decoupling term ensures that the state-invariant agent 316 focuses on persistent causal patterns rather than transient or batch-specific effects. Training separate critics 430 allows each agent to optimize the policy independently and specialize in its respective causal learning task.

Reward 438 defined as

$${\overline{ℛ}}_{t}^{l} = - 𝒮 ( {A}_{t}^{l} , {X}_{t}^{l} ) + {λ}_{1} {ℒ}_{{\tilde{𝒢}}_{t}^{l}}$$

where λ₂ is a weight coefficient is also applied. Since state-invariant information does not change over time, the state-invariant RL agent 316 is continuously updated throughout the training process.

The agents are both trained using the Adam optimizer. Other embodiments of the present invention can use stochastic gradient descent (with or without momentum), root mean squared propagation, adaptive gradient algorithm, Adadelta, Adam with weight decay fix, Nesterov-accelerated adaptive moment estimation, AMSGrad, evolved sign momentum, layer-wise adaptive moments for batching, etc.

Embodiments of the present invention include a baseline B for more stable training so that the objective of each agent is to minimize the temporal difference between a predicted reward [symbol] summed with [symbol] and the actual reward 436. The baseline is updated according to the formula [symbol] =γ· [symbol] +(1−γ)· [symbol] , where γ is the discount factor and [symbol] denotes the mean of the reward 436. The policy gradient is given by ∇J(ψ)= [symbol] {∇_{ψ} log π(ψ)[ [symbol] −(b+ [symbol] )]}, where J is the expected reward objective that the RL agents are trying to maximize according to:

$$J ( ψ ) = {𝔼}_{π ( ψ )} [ log π ( ψ ) \cdot ( R - ( b + \hat{R} ) ) ] .$$

π(ψ) is a policy parameterized by ψ, R is the actual reward 436, \hat{R} is the predicted reward by the critic 430, and b is the baseline to stabilize learning.

The estimated DAG expects to gradually converge as successive batches are processed. To avoid wasting computational resources a threshold for convergence is defined between the estimated DAGs of two consecutive batches within the same system state pₜ. In an embodiment of the present invention Jensen-Shannon (JS) divergence is employed according to:

$$ξ = 1 - JS ( {P}_{𝒢} ( {𝒢}_{t}^{l - 1} ) ‖ P ( {𝒢}_{t}^{l} ) )$$

where [symbol] (⋅) denotes the edge distribution of the corresponding graph. A larger indicates that the two graphs are more similar. When exceeds a threshold, the current estimated DAG is considered to have stabilized (converged) and will stop the learning process until a new system state arrives. JS can monitor the divergence between the edge distributions of consecutive DAGs.

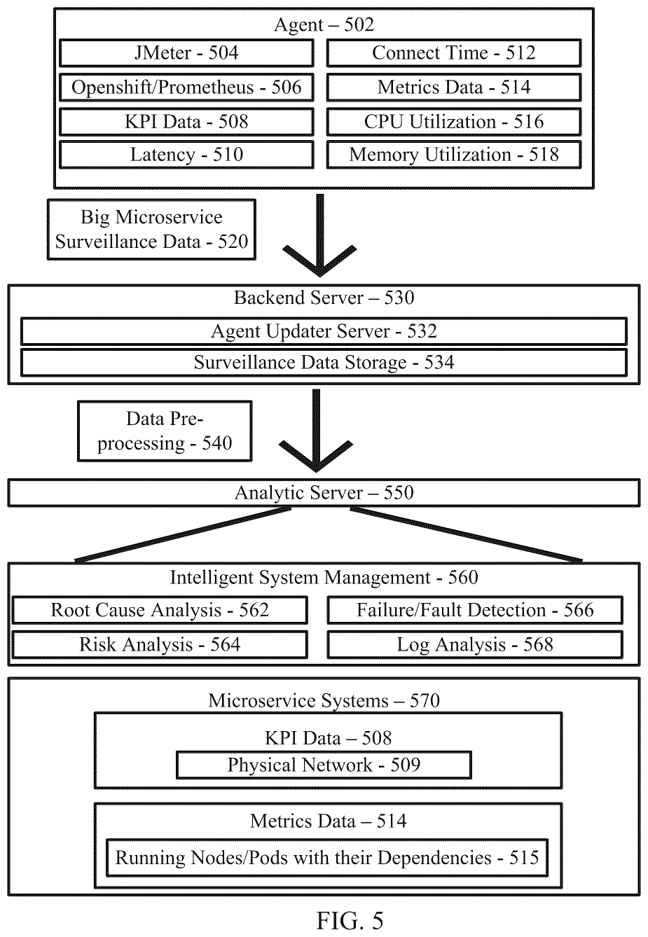

Referring to FIG. 5, a block diagram of the DAG RL is illustrated as an automated microservice intelligence system. Agent 502 installs JMeter 504 in the microservice system 570 to periodically send requests from JMeter 504 to microservice system 570 and collect system-level performance KPI data 508. Agent 502 also installs Openshift/Prometheus 506 to collect metrics data 514 of all containers/nodes and applications/pods, e.g., latency 510, connect time 512, CPU usage 516 and memory usage 518 of a running pod during a period of time. Backend servers 530 receives and pre-processes 540 big microservice surveillance data 520 from agent 502 and then sends data 520 to analysis server 550. Backend servers 530 has agent updater server 532 and surveillance data storage 534. Analysis server 550 runs the intelligent system management program 560 to analyze the data. Within intelligent system management program 560 is root cause analysis engine 562, risk analysis 564, failure and fault detection 566, and log analysis 568.

Agent 502 collects data 520 by employing the open-source JMeter 504 and Openshift/Prometheus 506. Two types of monitored data are used in the root cause analysis engine 562. JMeter 504 reports data of the whole system and the metrics data 514 of the running containers/nodes and the applications/pods. JMeter 504 data includes the system performance KPI data 508 information such as elapsed time, latency, connect time, thread name, throughput etc. The format of the data can be timeStamp, elapsed, label, responseCode, responseMessage, threadName, dataType, success, failureMessage, bytes, sentBytes, grpThreads, allThreads, URL, latency, IdleTime, Connect_time, etc.

Latency 510 measures the latency from just before sending the request to just after the first chunk of the response has been received. Connect time 512 measures the time taken to establish the connection, including SSL handshake. Both latency 510 and connect time 512 are time series data, which can indicate the system status and directly reflect the quality of service (whether failures events of the whole system have happened or not) because the system failure would result in the latency 510 or connect time 512 increasing. KPI data 508 can include physical network 509.

The metrics data 514 includes a number of metrics which indicate the status of an underlying component/entity of a microservice based on the nodes/pod and dependencies 515. The underlying component/entity can be an underlying physical machine/container/virtual machine/pod of a microservice. The corresponding metrics can be the CPU utilization/saturation 516, memory utilization/saturation 518, or disk IO utilization. All these metrics data 514 are time series data or can be converted to time series data. An anomalous metric of an underlying component of a microservice can be root cause of an anomalous JMeter 504 latency 510/connect time 512, indicating a microservice failure.

The change point detection or trigger point detection module receives batches of streaming data from a dynamic system (e.g., cloud systems). If no change point is detected, the system iterates to the next batch. If there is a change point, then the system returns the timestep and the features contribute to the correlation change.

While Jmeter is described here, alternative solutions can include proprietary software, Locust, k6, Artillery, Gatling, BlazeMeter, NeoLoad, StormForge/Performance, and AWS Distributed Load Testing, etc. Alternatives to OpenShift include Rancher, VMware Tanzu, Mirantis, K3s, MicroK8s, Amazon EKS, Google GKE, Azure AKS, Platform 9, Gardener, etc. Alternatives to Prometheus include InfluxDB, Graphite, OpenTelemetry+Backend, Datadog, New Relic, Amazon CloudWatch, Thanos, Cortex, VictoriaMetrics, etc.

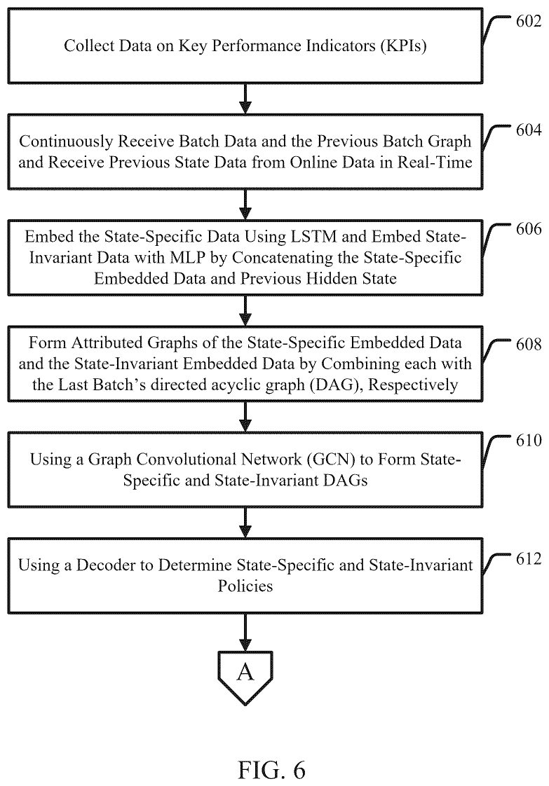

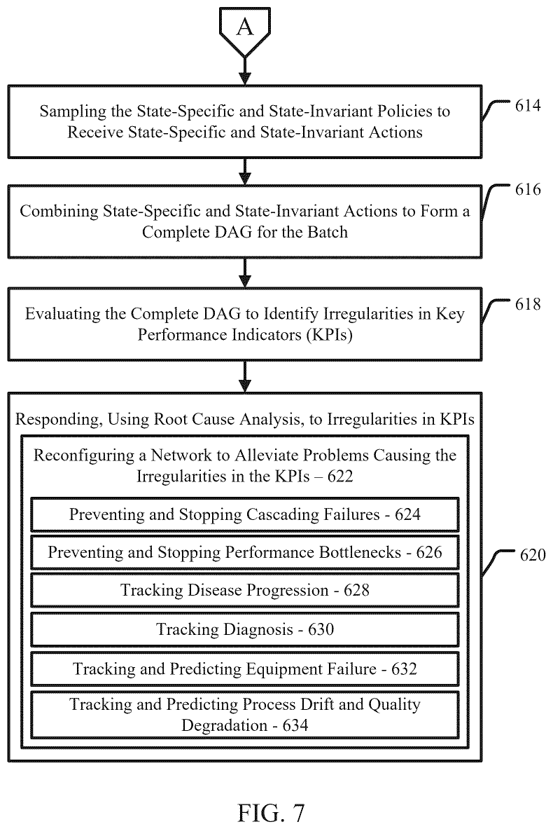

Referring to FIG. 6, a flow diagram of the DAG RL is illustrated. In block 602 batch data including KPIs is collected. The data can include, in non-limiting examples, latency, throughput, response time, network availability, jitter, bandwidth, error rates, uptime, network utilization, network speed, round-trip time, security, application performance, compliance, connectivity, conversion rate, projected revenue, signal strength, packet loss, mean time between failures, packet duplication, reported outages, etc. Block 602 can occur on a server, edge devices, or both. Block 602 can be collected continuously in real-time online.

In block 604 the data collected in block 602 can be continuously received in batches. Also, in block 604 the graph of the previous batch, the hidden state of the previous batch, the graph of the previous state, and the observed data from the previous state are all received for processing.

In block 606, state-specific and state-invariant embeddings are formed. The state-specific embedding is formed using LSTM. The state-specific embedding utilizes both the batch data from the current batch and the previous hidden state as inputs. The state-invariant embedding is formed using the previous state state-invariant embedding and the current state state-specific embedding. The state-invariant embedding uses MLP.

In block 608, attributed graphs for the state-specific and state-invariant embedded are formed. The state-specific graph is formed by combining the state-specific hidden state with the graph of the previous batch. The state-invariant graph is formed by combining the graph of the previous batch with the state-invariant hidden state. LSTM can be replaced with a gated recurrent unit (GRU), transformers, temporal convolutional networks (TCN), independent recurrent neural network (IndRNN), structured state space sequence model (S4), etc. MLP can be replaced with convolutional neural networks (CNN), recurrent neural networks (RNNs), LSTM, GRU, transformers, radial basis function networks (RBFN), support vector machines (SVM), decision trees, and graph neural networks (GNNs), etc.

In block 610, the state-specific graph and the state-invariant graph are encoded using a GCN. Alternatives to GCN can include graph attention networks (GATs), GraphSAGE, approximate personalize propagation of neural predictions (APPNP), gated graph neural networks (GGNN), message passing neural networks (MPNN), transformers on graphs, etc.

In block 612, a decoder is used to determine state-specific policy and state-invariant policy. In block 614, the state-specific policy and the state-invariant policy are sampled for obtain a state-specific action and a state-invariant action. In block 616, the state-specific action and state-invariant action form the complete DAG for the batch. In some embodiments this can be done using a convex combination for the fusion action vector.

In some embodiments of the present invention. In block 618, the complete DAG is evaluated to identify irregularities in the KPIs. In block 620, the method responds, using RCA to to irregularities in the KPIs. Responding to irregularities can include preventing and stopping cascading failures 624, preventing or stopping performance bottlenecks 626, tracking disease progression modeling 628, tracking diagnosis 630, tracking and predicting equipment failure 632, and tracking and predicting process drift and quality degradation 634.

In block 622 the method reconfigures a network to alleviate problems causing irregularities in the KPIs. Alleviating irregularities can include, reporting, notifying, logging, initiating patch procedures, locating the source of the irregularity, determining the cause of the irregularity, determining the urgency of remediation, or performing other actions relating to the irregularity in the KPIs. Additionally, block 622 can perform other functions proactively. For example, the framework can troubleshoot, alert, and/or patch the cause of the irregularity. If the irregularity is beneficial such as increased performance or improved prediction, the method can identify how to maximize the effects or otherwise repeat, replicate, or continue the irregularity. The notification and alert can be to a third party, network administrator, or other personnel.

Embodiments of the present invention can use non-KPI metrics. For example, in economics Gross Domestic Product (GPD) and Consumer Price Index (CPI) can be tracked. In medicine, the number of patients seen in a day and the average length of patient stay in the hospital can be tracked.

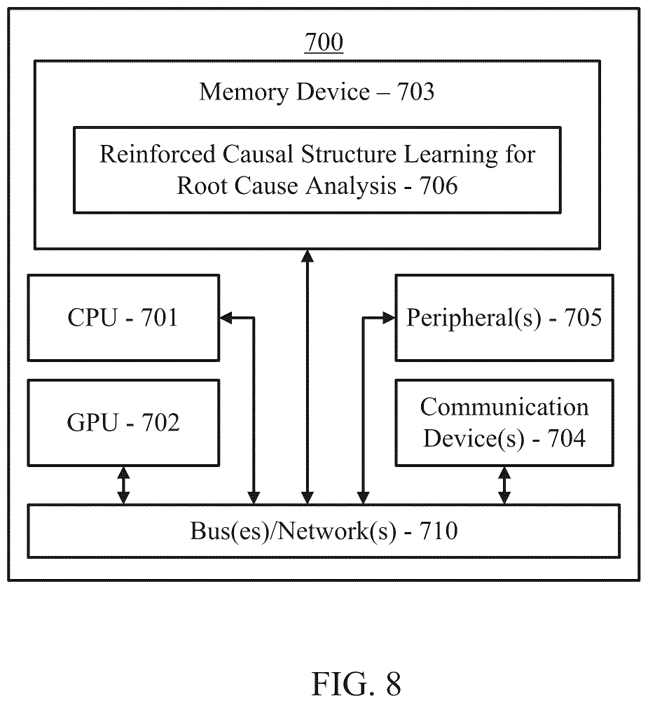

Referring to FIG. 8, a block diagram is shown for an exemplary processing system 700, in accordance with an embodiment of the present invention. The processing system 700 includes a set of processing units (e.g., CPUs) 701, a set of GPUs 702, a set of memory devices 703, a set of communication devices 704, and a set of peripherals 705. The CPUs 701 can be single or multi-core CPUs. The GPUs 702 can be single or multi-core GPUs. The one or more memory devices 703 can include caches, RAMs, ROMs, and other memories (flash, optical, magnetic, etc.). The communication devices 704 can include wireless and/or wired communication devices (e.g., network (e.g., Wi-Fi®, etc.) adapters, etc.). The peripherals 705 can include a display device, a user input device, a printer, an imaging device, and so forth. Elements of processing system 700 are connected by one or more buses or networks (collectively denoted by the figure reference numeral 710).

In an embodiment of the present invention, memory devices 703 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 703 store program code or software 706 for reinforced causal structure learning for root cause analysis. The training implements one or more functions of the systems and methods described herein for embedding new batch data and a previous hidden state to form state-specific embedded data and forming a state-specific attributed graph with the state-specific embedded data and a DAG from the previous batch. The software 706 further includes decoding the DAG to learn a state-specific policy, sampling an action from the state-specific policy to form a state-specific DAG, and combining the state-specific DAG with an action from a state-invariant action to form a complete DAG. Software 706 can also include evaluating the complete DAG to identify irregularities in KPIs and initiating RCA response techniques in response to irregularities in KPIs. The memory devices 703 can store program code for implementing one or more functions of the systems and methods described herein.

Of course, the processing system 700 may also include other elements (not shown), as readily contemplated by one of skill in the art, as well as omitting certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 700.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

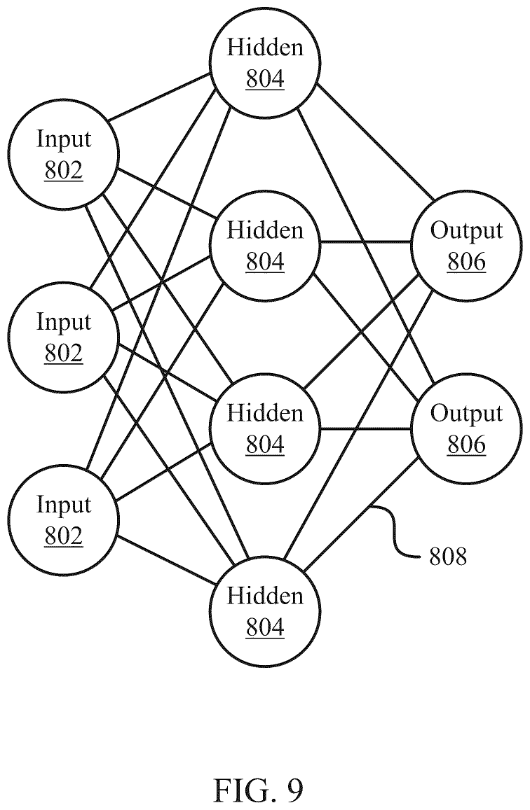

Referring to FIG. 9, a generalized diagram of a neural network is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bound objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 808 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

The ANN can be integrated into a reinforced causal structure learning for RCA by having the ANN evaluate the data to form embeddings (through the use of LSTM and MLP respectively). The data being processed in the RCA is sequential data coming batches. Specific types of ANNs are developed for sequential data called recurrent neural networks (RNNs). The LSTM is type of RNN that can “remember” information that forms long term dependencies that is useful for separating state-invariant data and state-specific data. LSTM can distinguish between variations in batches (e.g., temporary changes in latency) and consistencies in batches (e.g., core dependencies). MLPs are used to process and combine embeddings for the state-invariant agent, enabling a better understanding of persistent causal structures. Together, these components allow the system to perform accurate, explainable root cause analysis in dynamic environments.

The MLP can identify relationships with minimal causality when there may be multiple variables causing a single problem. For example, measuring network latency can identify several causes. The causes may stack on top of one another to cause poor latency rather than being a single problematic source. Identifying the problem can point to several sources which may need to be improved.

The MLP processes these variables simultaneously and can learn to recognize such combinatorial or additive effects. This allows the system to detect multi-cause scenarios, where improving just one variable may not resolve the issue, but jointly optimizing several inputs can restore normal performance. Identifying these minimal but collectively significant causes is useful for effective RCA by enabling a more comprehensive and targeted remediation strategy. There can be several modules in the ANN that can perform the same, similar, or different tasks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for root cause analysis (RCA) comprising:
embedding new batch data and a previous hidden state to form state-specific embedded data;
forming a state-specific attributed graph with the state-specific embedded data and a directed acyclic graph (DAG) from a previous batch;
decoding the DAG to learn a state-specific policy;
sampling an action from the state-specific policy to form a state-specific DAG;
combining the state-specific DAG with an action from a state-invariant action to form a complete DAG;
evaluating the complete DAG to identify irregularities in Key Performance Indicators (KPIs); and
responding, using RCA response techniques, to irregularities in KPIs.

2. The method of claim 1 wherein forming the state-invariant DAG further comprises:
concatenating the state-specific embedded data and the previous hidden state to form state-invariant hidden data;
forming a state-invariant attributed graph with the state-invariant embedded data and a DAG from the previous batch;
decoding the DAG to learn a state-invariant policy; and
sampling an action from the state-invariant policy.

3. The method of claim 2 further comprising:
applying a decoupling term to the state-invariant DAG.

4. The method of claim 1 wherein the complete DAG is formed by using parallel computing on multiple processing units.

5. The method of claim 1, further comprising:
applying a decoupling term to the state-specific DAG.

6. The method of claim 1 wherein the batches are continuously input and processed in an online setting in real-time.

7. The method of claim 1 wherein responding using RCA response techniques includes reconfiguring a network to alleviate problems causing irregularities in the KPIs.

8. A system for root cause analysis (RCA), comprising:
a memory device for storing program code; and
a processor device, operatively coupled to the memory device, for running the program code to:
embed new batch data and a previous hidden state to form state-specific embedded data;
form a state-specific attributed graph with the state-specific embedded data and a directed acyclic graph (DAG) from a previous batch;
decode the DAG to learn a state-specific policy;
sample an action from the state-specific policy to form a state-specific DAG;
combine the state-specific DAG with an action from a state-invariant action to form a complete DAG;
evaluate the complete DAG to identify irregularities in Key Performance Indicators (KPIs); and
respond, using RCA response techniques, to irregularities in KPIs.

9. The system of claim 8, wherein the memory further causes the processor to:
concatenate the state-specific embedded data and the previous hidden state to form state-invariant hidden data;
form a state-invariant attributed graph with the state-invariant embedded data and a DAG from a previous batch;
decode the DAG to learn a state-invariant policy; and
sample an action from the state-invariant policy.

10. The system of claim 9, wherein the processor further applies a decoupling term to the state-invariant DAG.

11. The system of claim 8, wherein the complete DAG is formed by using parallel computing on multiple processing units.

12. The system of claim 8 wherein the processor further applies a decoupling term to the state-specific DAG.

13. The system of claim 8 wherein the batches are continuously input and processed in an online setting in real-time.

14. The system of claim 8 wherein causing the processor to respond using RCA response techniques includes reconfiguring a network to alleviate problems causing irregularities in the KPIs.

15. A computer program product for root cause analysis (RCA), the computer program product comprising a non-transitory computer readable storage medium having program instructions embodied therewith, the program instructions executable by a computer to cause the computer to perform a method comprising:
embedding new batch data and a previous hidden state to form state-specific embedded data;
forming a state-specific attributed graph with the state-specific embedded data and a directed acyclic graph (DAG) from a previous batch;
decoding the DAG to learn a state-specific policy;
sampling an action from the state-specific policy to form a state-specific DAG;
combining the state-specific DAG with an action from a state-invariant action to form a complete DAG;
evaluating the complete DAG to identify irregularities in Key Performance Indicators (KPIs); and
respond, using RCA response techniques, to irregularities in KPIs.

16. The computer program product of claim 15 wherein forming the state-invariant DAG further comprises:
concatenating the state-specific embedded data and the previous hidden state to form state-invariant hidden data;
forming a state-invariant attributed graph with the state-invariant embedded data and a DAG from a previous batch;
decoding the DAG to learn a state-invariant policy; and
sampling an action from the state-invariant policy.

17. The computer program product of claim 15 wherein the complete DAG is formed by using parallel computing on multiple processing units.

18. The computer program product of claim 15 wherein the method further applies a decoupling term to the state-specific DAG.

19. The computer program product of claim 15 wherein the batches are continuously input and processed in an online setting in real-time.

20. The computer program product of claim 15 wherein responding using RCA response techniques includes reconfiguring a network to alleviate problems causing irregularities in the KPIs.
